(19) United States
(12) Patent Application Publication
(10) Pub. No.: US 2011/0290780 A1
(43) Pub. Date: Dec. 1, 2011

(54) Apparatus Having Scanner Lens for Material Processing by way of Laser

(75) Inventor: Pravin Sievi, Berlin (DE)

(73) Assignee: Scansonic MI GmbH, Berlin (DE)

(21) Appl. No.: 13/205,297

(22) Filed: Aug. 8, 2011

Related U.S. Application Data
(63) Continuation of application No. PCT/DE2010/000057, filed on Jan. 21, 2010.

(30) Foreign Application Priority Data
Feb. 9, 2009 (DE) 10 2009 008 126.7
Nov. 27, 2009 (DE) 10 2009 057 209.0

(51) Int. Cl. H05B 7/18

(52) U.S. Cl. 219/383

(57) ABSTRACT

The invention is a device for guiding a laser tool for processing a workpiece and includes a scanner optic, an image sensor that is optically integrated into a portion of the beam path of a workpiece processing beam, and at least one projector that is mounted externally to the scanner optics. Scanner optic, projector, and image sensor move together. The projector projects a second laser beam onto the workpiece. A semi-permeable deflection unit in the scanner optic is permeable to the second laser beam and impermeable to the workpiece processing beam. The image sensor is arranged on the side of the semi-permeable deflection unit facing away from the path of the workpiece processing beam. The measuring light is reflected from the workpiece into the scanner optic, through the semi-permeable deflection unit and then detected by the image sensor. The device enables mass production of fine fillet welds and flange welds.

This application is a continuation of PCT/DE2010/000057, filed on Jan. 21, 2010, and claims priority from German applications DE 10 2009 008 126.7, filed on Feb. 9, 2009, and DE 10 2009 057 209.0, filed on Nov. 27, 2009, both of which are incorporated herein in their entirety.

### BACKGROUND INFORMATION

1. Field of the Invention

The invention relates to a device equipped with scanner optics configured for pre- or post-objective scanning for use with laser-processing of materials or workpieces, and particularly, for laser welding.

2. Discussion of the Prior Art

It is known to use scanner optics with deflection units to precisely guide a laser beam. Mirrors are customarily used as deflection units. Considerably higher speed and acceleration variables can be achieved with the scanner optics than with guide machines. Such scanning optics also allow seams and contours to be scribed onto the workpieces that are to be processed during the travel motion of the guide machine, independent of the guide machine, thus achieving a long-term reduction in production times.

Scanner optics operate according to either the pre-objective scanning principle or the post-objective scanning principle. With pre-objective scanning, the divergent laser beam first runs through a collimator, is then redirected over one or several active, i.e., adjustable, deflection units, and finally imaged via a focuser onto the workpiece to be worked. The focuser is equipped with an optical lens or a plan-field objective lens.

Scanner optics operating according to the post-objective scanning principle also have a collimator, but the focuser is positioned in front of at least one deflection unit, i.e., the deflection unit deflects an already focused laser beam onto the workpiece.

In addition to the active deflection units, passive, i.e., fixed or non-adjustable deflection units, which are used to guide the beam, are also frequently used in the scanner optics.

With conventional scanner optics, however, the accuracy of the laser spot that can be achieved when working the workpiece is relatively low. The reason for this lies in the cumulation of errors in the tolerance chain of the total system, which includes the guide machine, the scanner optics, and the workpiece.

The scanner optics are generally installed such that they and the workpiece move relative to each other. Either the scanner optics device is fixed in place and the workpiece moves relative to it, or the workpiece is fixed in place and the scanner optics device is moved by means of a guide machine. The actual vector of the relative speed and the actual Cartesian position between the processing point on the workpiece and the scanner optic also have to be known to the scanner optics, in order to first determine the starting point for the laser spot and then to subsequently guide the point according to the geometrical programming. While the vector of the relative speed can still be determined comparatively accurately, determining the position of the scanner optic relative to the workpiece is extremely inaccurate, due to elastic distortions of the arrangement, the limited resolution of the path sensors of the guide machine, manufacturing tolerances of the workpieces, and position deviations of the workpiece caused by the clamping device.

Errors from the scanner optics, due primarily to the limited dynamics of the drives and the limited resolution of the path sensors, increase the inaccuracy. The distance between the workpiece and the scanner optics can be great, in which case, small changes or deviations in the deflection mirrors result in large changes in the position of the laser spot. Due to this and the unfavorable optical image ratios, these errors have a particularly strong influence on the positioning accuracy. When assessing the errors, one must finally also consider the fact that the diameter of the laser spot is typically only 0.3 mm to 0.6 mm.

Conventional scanner optics are therefore employed only in areas in which the required positioning accuracy of the laser spot is relatively low. For example, scanner optics are used in automobile manufacturing only for lap welds, whereby the width of the lap weld is selected in such a way that the welds on the workpiece remain within the permitted tolerance range, even when the cumulative tolerances are all unfavorable. This results in unnecessarity large flange widths, which is counterproductive, because, in automobile manufacturing, to goal is to produce lighter auto bodies containing less material. It is not possible to weld fillet welds on the lap joint or to weld flange seams. If, however, one could achieve acceptable fillet welds, the flange widths could be significantly reduced and the welding speed increased with the same laser output.

Patent application DE 10 2007 027 377 A1 is known from the prior art. The invention relates to apparatus and a method of using laser beams to process a workpiece. The apparatus comprises a processing optic with at least one element deflecting or focusing the laser beam, an optical measuring system for determining a butt joint, a signal processing device that determines a spatial deviation of the processing point of the laser beam to the joint impact, and a control that, in order to minimize a spatial distance between the processing point and the butt joint, influences the beam-deflecting and/or beam-focusing element of the processing optics, depending on the deviations of the processing point to the butt joint. The optical measuring system gauges the topography of the workpiece through the processing optic by means of at least two light beams or at least one circular image.

Both the transmitter and the receiver of the optical measuring system are integrated into the beam path of the processing optics, and because of this, only relatively unfavorable triangulation angles can be achieved with the measuring system. It is also a drawback that the processing optics mute or possibly distort the signal of the light transmitter.

What is needed therefore is laser apparatus equipped with a scanner optic that recognizes the processing positions of a workpiece to be worked, independently and with little error. What is further needed is such an apparatus that enables fillet welds or flange welds to be executed.

### BRIEF SUMMARY OF THE INVENTION

The basis for the invention is apparatus for processing materials or workpieces with lasers. The apparatus includes a scanner optic that is moveable relative to the workpiece that is to be processed, a guide machine or tool carriage that moves the laser tool along a pre-defined path, a projector, and an image sensor. It is well known in the field of workpiece processing, and particularly in the field of, for example, laser welding, to use a guide machine to move a tool along a pre-defined processing path. Thus, the guide machine and the mounting of the scanner optic on the guide machine are not shown in any detail.

The scanner optic operates according to the pre-objective or post-objective scanning principles and guides the projected laser beam by means of one or more active and/or passive deflection units. The projector serves to project measuring light in the form of measuring structures onto the workpiece that is to be processed. The image sensor is sensitive to the wavelength of the measuring light emitted from the projector.

According to the invention, the projector is positioned outside of the path of the beam projected by the scanner optics, i.e., outside the beam path of the tool for processing the workpiece or material. The measuring light emitted from the projector generates at least one line that extends transverse to the longitudinal direction of the weld to be created on the workpiece, preferably extending across the entire sphere of action of the scanner optics. This measuring light beam is directed along the longitudinal direction of the weld at a pre-set distance in advance of the strike position of the laser beam. The projector and the scanning optic move as one, and, therefore, the lines of light from the measuring light beam always remain a set distance from the strike position of the laser beam, thus preventing lines from the projected measurement light beam from crossing the laser beam. This setup prevents or reduces interference with the measuring signal, caused by environmental influences that arise from the process. In a laser welding process, for example, such environmental influences include temperature gradients, the resulting plasma torch, welding smoke, and welding spatter.

The image sensor is placed behind a deflection unit, that is, on the side of the deflection unit that faces away from the path of the workpiece processing beam. That particular deflection unit is permeable to the wavelength range of the light emitted by the projector and reflects the wavelength range of the light emitted by the processing laser. This is done to decouple the measurement light beam from the workpiece processing beam.

The image sensor is integrated into the beam path of the scanner optics, and consequently, its measuring field moves in all existing degrees of freedom synchronously with the laser processing beam. Positional and geometrical errors from the overall optical or mechanical construction cannot affect the measuring results from the sensor, because the laser processing beam in the scanner optics runs coaxially, or almost coaxially, to the incident axis of the sensor in at least one area of the optics. More favorable triangulation angles are achieved with the externally mounted projector than with projectors integrated into the beam path of the scanner optics. Furthermore, the scanner optics neither mute nor distort the light emitted by the projector.

Thin sheet metals, for example, sheet metal that is frequently used in automobile manufacturing, can be welded without difficulty with this arrangement of the image sensor and the projector, using only one measuring light line. The use of one measuring line allows the height difference, the offset transverse to the longitudinal direction of the weld, and the rotation around the longitudinal direction of the weld to be determined. An increase in the correction dimensions, i.e., controlling the process with two or three projection lines, may be required for particularly difficult processes. Using more than three projection lines achieves no further improvement, because all spatial dimensions can be determined with three projection lines.

For this purpose, the device is equipped with a control unit, which, using triangulation and/or light-slit methods, calculates the processing positions on the workpiece from the sensor data and, with this positioning data, controls the active deflection units of the scanner optics. Such control units are known in the industry and are not described with any detail. Based on the known angular relationship between the projector and the sensor, the position in space can be determined from the receiving beam in the measuring field of the sensor, using well-known triangulation, i.e., one-dimensional, or light-slit, i.e., multi-dimensional, methods. In the multi-dimensional field, the sensor no longer detects just one measuring point, but instead, a profile that contains geometrical reference values with which the processing position is determined. Thus, it is possible to operate the deflection units of the scanner optics such that the laser beam is always projected comparatively accurately directly onto the target processing position.

The image sensor is arranged behind a passive deflection unit. A laser is provided as the light source for the projector, whereby the projector emits light at a different wavelength than the light emitted from the processing laser. The passive deflection unit is constructed as a semi-permeable mirror that is coated with interference coatings. The interference coatings reflect the light from the processing laser and allow the light from the projector's laser to pass through it.

In the description below, the beam path is defined from the perspective of the processing site, i.e., the description begins at the processing site on the workpiece and ends at the laser.

Placing a passive deflection unit in the beam path behind the last active deflection unit of the scanner optics, or placing a passive deflection unit directly behind the focusing unit in the beam path are particularly suitable configurations of the device according to the invention for decoupling the sensor signal.

In conventional practice, the scanner optic is mounted on a guide machine, which moves the scanner optic relative to the workpiece. Thus, the process speed corresponds to the speed specified by the guide machine, i.e., process speed and guide speed are the same. It may be desirable, however, to work with different speeds. In one of the embodiments of the device according to the invention, the control unit synchronizes the active deflection units of the scanner optics with the guide machine such that the scanner optics, in addition to guiding the weld, can speed up the process speed relative to the guide speed by moving the laser beam in the direction of movement specified by the guide machine, or conversely, can slow down the process speed by moving the laser beam in a direction opposite the movement of the guide machine.

Prior to starting the welding process, the active deflection units of the scanner optics are pivoted far enough in the advance direction so that the measuring light line(s) is/are positioned at the lower end of the sensor measuring field. The welding process is started at this end, after the laser spot has been positioned on the edge of the joint. The required process speed is synchronized with the actual movement of the guide machine by an equalizing or compensating movement of the scanner optics in the advancing direction. In order to achieve higher cycle times, the guide speed is generally higher than the process speed. As a result, the projection line travels from the lower end of the sensor measuring field to the upper end. If the contours of the workpiece are sufficiently linear, the equalizing movement can also be extrapolated beyond the visual range of the sensor/camera image.

In principle, with a fixed position projector, it is basically not possible to track the weld transverse to the longitudinal direction of the weld by projecting lines onto the workpiece. If continuous weld tracking is to be achieved for small workpiece radiuses or workpiece edges that are at a steep angle to one another, the guide machine must re-orient the scanner optic within a short time/distance section, something that is technically very difficult to do. This limitation can be avoided from the start, either by using several projectors or by using one projector that is positioned in such a way that it can be pivoted about the processing point with an additional degree of freedom. This requires that the actual position of the measuring beam be detected for all degrees of freedom and calculated from the sensor data. Electromechanical, optical, or electropneumatic means may be used to pivot the projector.

Furthermore, during the measuring operation, the projector can also be actively positionable in the longitudinal direction of the weld by means of one or several separate degrees of freedom of the projector. This makes it possible to keep variable the advance between the measuring light lines from the projector and the laser spot, and thus also the sensor measuring field. Also, utilizing the entire scanner field via a synchronized movement between the projector and the deflection units of the scanner optics provides a larger weld area in the longitudinal direction of the weld, or allows a greater difference between the guide and process speeds.

Process-related environmental influences, such as the thermal plasma torch, welding smoke, and welding spatter, are inevitably created during the laser welding process and they can interfere with the image sensor signal. A process jet may be provided on the device, to keep such influences away from the projector(s). The process jet is connected to a compressed gas, i.e, pressurized air, tank and provides an airstream that transports the process-related environmental influences out of the area surrounding the projector. As with the projector, the process jet is connected to the scanner optics, so that it moves together with the projector. A fixed-position process jet, several process jets, or a process jet that is pivotably mounted in correspondence with a pivotably mounted projector may be implemented. The desired configuration of process jet(s) depends on the configuration of projectors used, for example, a single fixed position projector, a plurality of projectors, or a pivotably mounted projector.

### BRIEF DESCRIPTION OF THE DRAWINGS

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

FIG. 1 is a schematic side view of the device according to the invention, illustrating a scanner optic configured for pre-objective scanning.

FIG. 2 is a top view of the device of FIG. 1.

FIG. 3 is a front view of the device of FIG. 1.

### DETAILED DESCRIPTION OF THE INVENTION

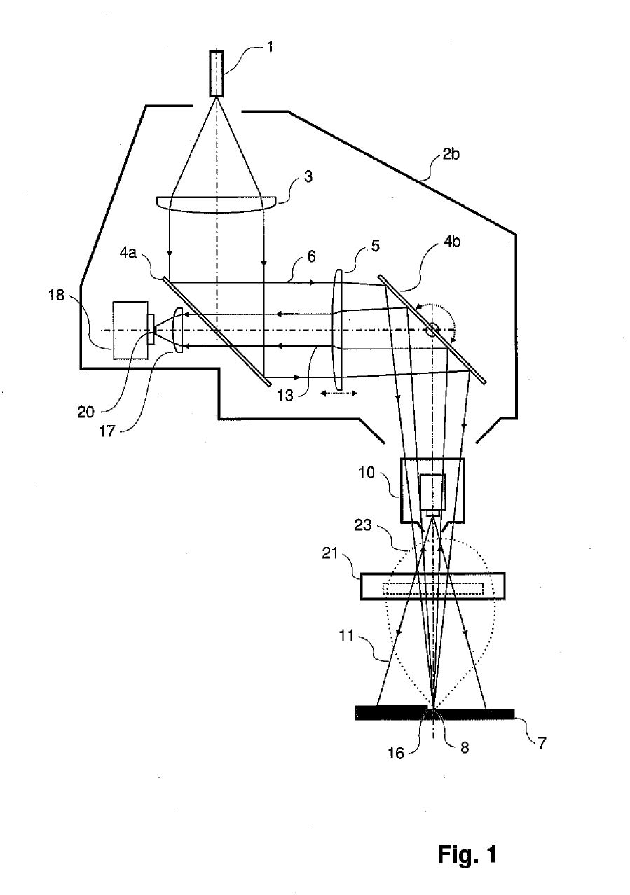

FIGS. 1 to 3 are schematic illustrations of a device 100 with a scanner optic for processing a workpiece using a laser as the processing tool. Scanning optic devices are typically mounted on a guide machine or tool carriage that moves the scanning optic, along with the processing tool, relative to the workpiece. This technology is known and is not described herein.

The device 100 according to the invention comprises a workpiece processing laser 1, scanner optics 2b, and a measuring system. The scanner optics 2b guides a workpiece processing beam 6 onto a workpiece 7. In the embodiments described herein, the workpiece processing beam or laser tool 1 is used to create a weld on the workpiece 7, but it is understood that the intended use of the device 100 described herein is not limiting and that the device may be used for other processes. The measuring system, described below in more detail, provides data relating to the geometry and other properties of the processing path, in this case, a weld seam, to the scanner optics by processing an incoming measuring beam 19 that is reflected from the workpiece 7.

The scanner optics 2b comprises a collimator 3, a focuser 5, a passive deflection unit 4a, and an active deflection unit 4b. The scanner optics 2b as set up in the embodiments shown herein functions according to the principle of post-objective scanning, but it is just as possible for the scanner optics to function according to the principle of pre-objective scanning. The passive deflection unit 4a is constructed as a semi-permeable mirror that is permeable to the wavelength of light emitted by the projector 10 and the active deflection unit 4b constructed as a mirror that is reflective of the wavelength range of a laser beam emitted from the laser 1. Interference coatings are applied to the semi-permeable mirror, so that the passive deflection unit 4a is non-permeable, i.e., reflective, for the wavelength range of light emitted by the workpiece processing laser 1.

The workpiece processing beam 6 emitted from the laser 1 is guided through the scanner optics 2b onto a target point on the workpiece 7. In the scanner optics, the laser beam 6 is collimated by a collimator 3, and then guided by the passive deflection unit 4a to a focuser 5, where it is focussed. The beam 6 then strikes the active deflection unit 4b, which deflects the beam 6 onto the workpiece 7. The strike position 8 of the beam 6 on the workpiece 7 is adjusted or changed by adjusting the active deflection unit 4b. The field of action 9 of the scanner optics 2b is defined by the maximal area onto which the active deflection unit 4b can deflect the beam 6 to a strike position 8.

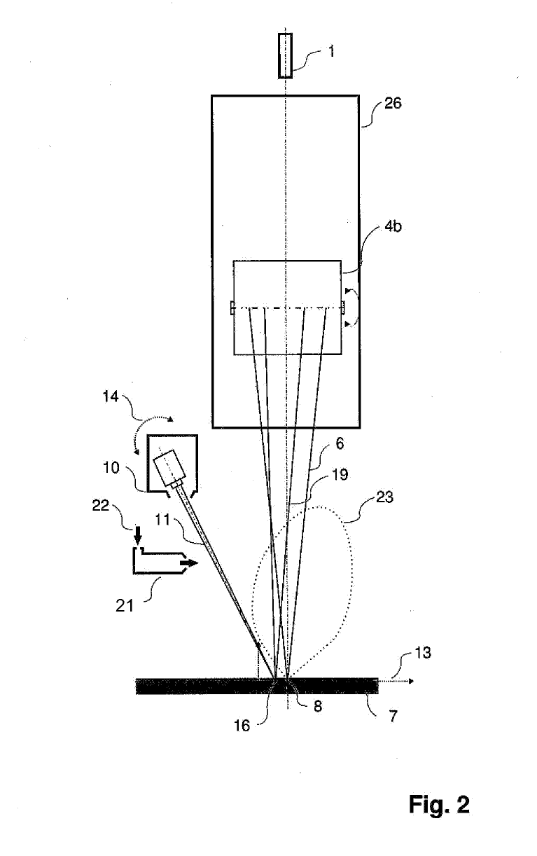

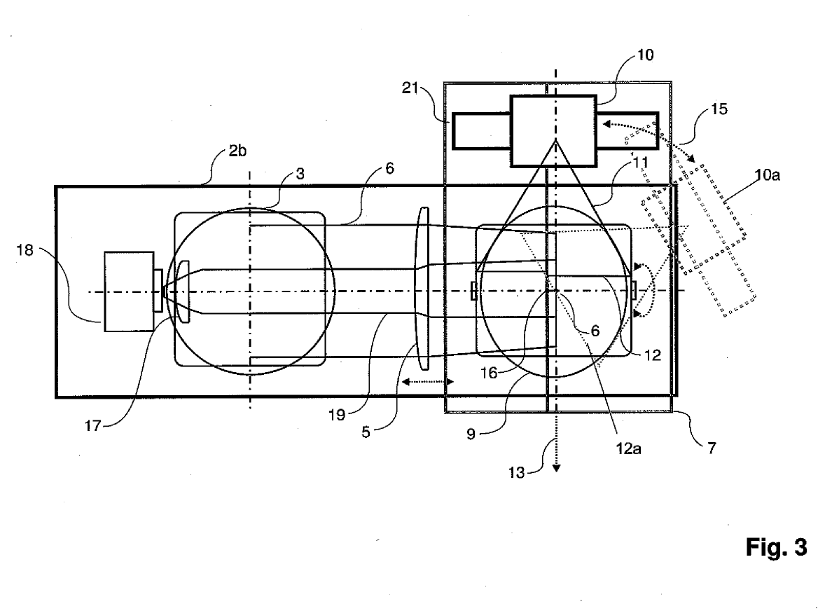

The measuring system comprises an image sensor 18 that is arranged behind the passive deflection unit 4a and a projector 10 that emits a measurement light beam 11. The projector 10 is mechanically connected to the scanner optics 2b and mounted so as to be outside of the projected workpiece processing beam 6, as shown in FIGS. 2 and 3, so that a measurement light beam 11 emitted from the projector does not cross the workpiece processing beam 6. The laser-produced measuring light beam 11 is indicated by projection lines 12 shown in FIG. 3. These projection lines 12 extend transverse to the longitudinal direction of the weld 13 on the workpiece 7.

The projector 10 has degrees of freedom 14 in the longitudinal direction of the weld 13, shown in FIG. 2, and also degrees of freedom 15, shown in FIG. 3, such that the projection lines 12 are pivotable about a pre-determined or target processing position 16. The projection lines 12a correspond to a repositioned projector 10a, both illustrated with broken lines. This ability to pivot the projector about the target position 16 enables continuous weld tracking for seams with small radiuses or angles.

The measurement light beam 11 strikes the workpiece 7 and is reflected into the scanner optics 2b. The reflected measurement light beam, referred to now as a sensor incoming beam 19, strikes the active deflection unit 4b and is then deflected onto the passive deflection unit 4a. The passive deflection unit 4a is permeable to the wavelength of the sensor incoming beam 19, so this beam 19 penetrates the passive deflection unit 4a, passes through a sensor focuser 17, and then on into a sensor measuring field 20 of the optical image sensor 18. This path defines the sensor incoming beam 19 of the measuring system. The focuser 17 is constructed as a lens and focuses the sensor incoming beam 19.

The laser welding process inevitably creates environmental influences, for example, temperature gradients, welding smoke, welding spatter, etc., that may influence the accuracy of the measuring system. For this reason, one or more jets 21 are mounted on the device 100 to provide a stream of compressed gas 22 to blow process-related environmental influences 23 that are produced by the laser welding away from the projector 10 as completely as possible. The jet 21, being mounted on the device 100, along with the projector 10, moves along with the projector, so that it remains properly positioned.

It is understood that the embodiments described herein are merely illustrative of the present invention. Variations in the construction of the scanner optics may be contemplated by one skilled in the art without limiting the intended scope of the invention herein disclosed and as defined by the following claims.

What is claimed is:

1: A device for performing a process on a workpiece with a laser beam, the device being used with apparatus that includes a guide machine that travels in a forward direction at a pre-defined guide speed, so as to move the laser beam along a processing path, the device comprising:
a laser that emits a workpiece processing beam;
a scanner optic that is moveable relative to the workpiece to be processed, that receives the workpiece processing beam, and that projects this workpiece processing beam along a first beam path onto a strike position on a workpiece, the scanner optic having deflection units that include a passive deflection unit and an active deflection unit, and a control unit that controls the active deflection unit;
a projector that is moveable with the scanner optic and mounted outside of the first beam path, the projector projecting a measurement light beam in a form of measurement structures onto the workpiece, the measurement light beam being projected along a second beam path; and
an image sensor that is moveable with the scanner optics and sensitive to a wavelength range of the measurement light beam;
wherein the measurement light beam comprises at least one line of light that extends transverse to a longitudinal direction of the processing path;
wherein the projector projects the measurement light beam to a position on the workpiece in advance of the strike position;
wherein the second beam path is optically decoupled from the first beam path; and
wherein the deflection units include a semi-permeable deflection unit and the image sensor is arranged on a side of the semi-permeable deflection unit that faces away from the first beam path, the semi-permeable deflective unit being permeable to the measurement light beam and reflective of the wavelength of the workpiece processing beam.

2: The device of claim 1, wherein a light source for the projector is a laser and the measurement light beam is a laser beam having a wavelength range that is measurably different from the wavelength range of the workpiece processing beam.

3: The device according to claim 1, wherein the passive deflection unit is constructed as a semi-permeable mirror that is coated with interference coating.

4: The device according to claim 1, wherein the active deflection unit includes a first active deflection unit and a last deflection unit, the first deflection unit being in the first beam path and closest to the workpiece and the last active deflection unit being in the first beam path and farthest away from the workpiece; and
wherein the passive deflection unit is coupled to the last active deflection unit;
and wherein the image sensor is placed on the second side of the passive deflection unit.

5: The device according to claim 1, the scanner optic including a focuser, wherein, tracing the first beam path from the workpiece back toward the laser, the passive deflection unit is positioned behind the focuser.

6: The device according to claim 1, the scanner optic having a work sphere that has a length that extends in a direction of the processing path and a width that is transverse to the direction of the processing path, and wherein the measurement light beam extends across the width of the work sphere.

7: The device according to claim 1, wherein the measurement light beam is projected onto the workpiece, reflected from the workpiece;
wherein the measurement light beam carries positioning data and becomes a sensor input beam that is projected along the second beam path and then detected by the image sensor;
wherein the control unit calculates a processing position on the workpiece from the positioning data obtained from the image sensor; and wherein the control unit controls the active deflection unit of the scanner optics based on the positioning data.

8: The device according to claim 7, wherein the active deflection unit includes a plurality of active deflection units and the control unit controls at least one active deflection unit.

9: The device according to claim 7, wherein the control unit synchronizes the active deflection unit with the guide speed, such that the scanner optic selectively changes a process speed relative to the guide speed by moving the workpiece processing beam in the direction of movement specified by the guide machine to speed up the process speed and moving the workpiece processing beam in an opposite direction of movement, relative to the guide machine, to slow down the process speed.

10: The device according to claim 1 wherein the projector includes a plurality of projectors for multi-axial workpiece processing.

11: The device according to claim 1, wherein, for multi-axial workpiece processing, the projector includes at least one projector that is mounted so as to be pivotable around the strike point of the workpiece processing beam.

12: The device according to claim 1, further comprising at least one process jet that is mounted on the device so as to be movable together with the scanner optic, wherein the at least one process jet provides a stream of compressed gas that serves to remove an environmental influence that may interfere with a signal of the image sensor.

13: The device according to claim 12, wherein the projector includes a plurality of projectors and the at least one process jet includes a corresponding plurality of processing jets.

14: The device according to claim 12, wherein the projector is a pivotably mounted projector, and wherein the at least one process jet includes a plurality of process jets that are provided as needed to prevent the environmental influence from interfering with the signal of the image sensor.

15: The device according to claim 12, wherein the projector is a pivotably mounted projector and the at least one process jet is also pivotably mounted.

16: The device according to claim 12, wherein the process is a welding process and the environmental influences include a temperature gradient, welding smoke, and weld spatter.

17: The device according to claim 1, wherein the scanner optic is configured for pre-objective processing.

18: The device according to claim 1, wherein the scanner optic is configured for post-objective processing.

19: The device according to claim 1, wherein the process is a welding process.
